(19) United States
(12) Patent Application Publication
(10) Pub. No.: US 2014/0188660 A1
(43) Pub. Date: Jul. 3, 2014

(54) METHOD AND APPARATUS FOR CONVEYING THE RIGHT TO BROKER REAL PROPERTY TRANSFERS

(71) Applicant: Steven B. Daum, Greenwich, CT (US)

(72) Inventor: Steven B. Daum, Greenwich, CT (US)

(21) Appl. No.: 14/090,633

(22) Filed: Nov. 26, 2013

Related U.S. Application Data
(63) Continuation of application No. 12/101,653, filed on Apr. 11, 2008.
Application No. 12/101,653 is a continuation-in-part of application No. 11/705,256, filed on Feb. 12, 2007, now abandoned.
(60) Provisional application No. 60/773,178, filed on Feb. 14, 2006.

(51) Int. Cl. G06Q 30/06; G06Q 50/16

(52) U.S. Cl. CPC G06Q 30/0613; G06Q 50/16
USPC 705/26.41

(57) ABSTRACT

A method of doing business to refer the right to broker the sale of real property is disclosed. Additionally, methods and systems to measure the value of the business are disclosed. The methods and systems include determining the value of the properties and determining the value of the right to broker the properties on a networked based computer system as well as a single personal computer.

### STATEMENT OF RELATED CASES

The present application is a continuation of U.S. patent application Ser. No. 12/101,653, which is a continuation-in-part of U.S. patent application Ser. No. 11/705,256 filed on Feb. 12, 2007 which relates to and claims the benefit of and priority to U.S. Provisional Patent Application Ser. No. 60/773,178, filed on Feb. 14, 2006, which applications are hereby incorporated by reference.

### BACKGROUND OF THE INVENTION

The present invention relates to the transfer of interests in real property.

Property owners typically use licensed brokers/agents to sell their properties. The brokers/agents charge a fee for providing services to sell a property. The fee is usually a percentage of the sales price and is generally collected at the closing of the sale of the property. The fee is usually split between the broker/agent representing the seller and another broker/agent representing the buyer. The services provided by the selling broker/agent includes listing the property in a multiple listing service, showing the house to other brokers/agents and potential buyers and generally advising the owner in the sale of property. These agents are generally referred to as listing agents.

Competition is very high among brokers/agents to obtain property listings to be the selling broker/agent (the listing agent). A method and apparatus that recognizes the high competition among brokers/agents and is designed to enable brokers/agents to more easily obtain listings as the selling broker/agent and that offers the owners of property a present value would be a valuable service within the real estate industry.

### SUMMARY OF THE INVENTION

The present invention provides a method and apparatus for providing a property owner with a consideration in exchange for the right to refer a real estate broker for the future sale of the property by the property owner.

The method, in accordance with another aspect of the present invention, can further include signing a contract evidencing the future right to refer a broker for the brokerage of the sale of the property and optionally recording the contract in a recording office. In accordance with one aspect of the present invention, consideration is paid to the owner when the right to refer a broker to broker the sale of the property is acquired.

In accordance with a further aspect of the invention, the right to refer the brokerage of the sale of the property may be sold to a third party. In accordance with applicable laws, the third party preferably will be a licensed real estate broker.

In accordance with further aspects of the present invention, systems and processes are provided to track and to determine the value of the business. The purchase price and sales price of the referral rights are tracked and determined. Additionally, the purchase price and the revenue realized from acting as a broker, for each property, are determined. Other aspects of the property can also be tracked and determined.

Each of these systems and processes help determine the value of the business. The system can be a stand-alone computer or a networked based system. Individual offices can provide their results to a central server and the results for the individual offices and the entire business can be determined at the server.

In accordance with one aspect of the present invention, the method can include signing a contract evidencing the right to broker the sale of the property and optionally recording the contract in a recording office. The consideration can be paid to the owner when the right to refer a broker to broker the sale of the property is acquired. Further, the right to broker the sale of the property can be sold to a third party.

A method in accordance with one aspect of the present invention can include buying a right to refer a broker to broker the sale of a plurality of properties at future dates, determining a value of each of the plurality of properties and summing values of each of the plurality of properties to determine a summed value. The value can be a current value of each of the plurality of properties or can be a projected future value of each of the plurality of properties. Further, both values can be determined and stored. The steps can be performed in one or more computers. Any of the steps can be performed in a client computer or in a server computer. For example, the step of determining the value of each of the plurality of properties can be performed on a client computer and the step of summing the values of each of the plurality of properties can be performed on a server computer. Alternatively, they can all be performed on a single computer.

The present invention can also include the step of determining a value of the right to refer a broker to broker the sale of each of the plurality of properties from the summed value. The value of the right to broker the sale of each of the plurality of properties can be determined as a percentage of the summed value.

A system that performs the above steps is also contemplated. The system can include a client computer and a server computer or a single computer. Any of the steps can be performed on either a client computer or a server computer.

Another aspect of the present invention is a method that includes determining one or more costs associated with buying a right to refer a broker to broker a sale of one or more properties, determining a revenue received as a result of the right to broker the sale of the one or more properties and determining a profit in accordance with the revenue and the one or more costs. The revenue received can be as a result of acting as a broker for the property or as a result of selling the right to broker the sale. Systems for performing these steps are also contemplated.

### DESCRIPTION OF THE DRAWINGS

FIG. 1 illustrates a transaction in accordance with one aspect of the present invention.

FIG. 2 illustrates a system in accordance with another aspect of the present invention.

FIGS. 3 and 4 illustrate processes in accordance with further aspects of the present invention.

FIG. 5 is a diagram illustrating transactions between different participants in accordance with an aspect of the present invention.

FIG. 6 is a diagram illustrating relations between a marketing partner and homeowners in accordance with another aspect of the present invention.

FIG. 7 is a diagram illustrating transactions in accordance with a further aspect of the present invention.

FIG. 8 is a diagram illustrating transactions in accordance with yet a further aspect of the present invention.

FIG. 9 is a diagram illustrating transactions in accordance with yet a further aspect of the present invention.

FIG. 10 is a diagram illustrating an aspect of the present invention involving a broker

FIG. 11 is a diagram illustrating another aspect of the present invention involving a broker.

FIG. 12 is a diagram illustrating yet another aspect of the present invention involving a broker.

FIG. 13 is a webpage illustrating an aspect of the present invention.

FIG. 14 is a webpage illustrating another aspect of the present invention.

FIG. 15 is a webpage illustrating yet another aspect of the present invention.

### DESCRIPTION OF A PREFERRED EMBODIMENT

In accordance with one aspect of the present invention, an organization obtains the right to refer a real estate broker to a property owner in the future when the property owner decides to sell the property. The organization can be a business entity or an individual. The organization may obtain the rights through a purchase arrangement or by other means. In some cases, the right to refer a real estate broker can include the right to act as a broker.

In accordance with a further aspect of the present invention, the organization enters into an agreement with the property owner that evidences the organization's right to refer a broker or agent to the property owner when the property owner decides to sell the property. In accordance with yet another aspect of the present invention, the organization can enter into an agreement to enter into a listing agreement with the property owner in the future.

The organization receives the right to refer a broker or an agent when the property is listed to be sold. Alternatively, the organization can also sell the right to act as a broker or an agent at any time after acquiring the right to act as a broker.

The organization pays valuable consideration to the property owner to receive the right to refer a broker in the future. The consideration can be cash, gift card or any other form of consideration. It can also be in the form a tangible item, such as a large screen television. It can also be a service provided by a third party over time, such as x number of months or years of landline or wireless telephone service, cable or satellite TV service, insurance, or the consideration may be applied in a manner to provide a discount to the homeowner in the homeowner's cost of such service(s). This allows the property owner to realize a present value from the future sale of the property, and the organization receives a future value—the right to receive a referral fee by referring a broker for the sale of the property.

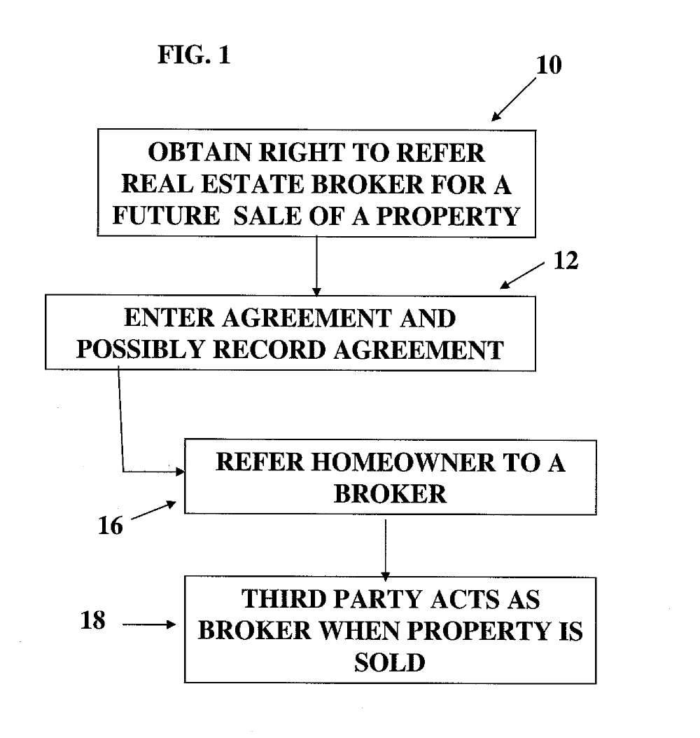

Referring to FIG. 1, the process is shown. In step 10, the organization obtains from a property owner the right to refer a broker during the sale of the property in the future. In step 12, a contract or agreement is entered into, preferably by signing, and the contract is optionally recorded in the appropriate local recording office, such as the Records Hall. This provides notice to future buyers of the property of the organization's right to refer a broker.

In accordance with one aspect of the present invention, a home owner accesses a web site. The homeowner enters a zip code of their home. The system and the web site automatically generate a list of cooperating brokers that participate in the program of the present invention. The homeowner selects the broker they would like to use for the future sale. The home owner also enters information sufficient to confirm the credit worthiness of the homeowner. The system then obtains the relevant credit history through automated methods in conjunction with one or more third party vendors. The additional vendors may be utilized to verify information or to spread the demand, as desired and as necessary. If the homeowner is approved, the home value is confirmed to determine the consideration they receive. The homeowner must have sufficient value in the property to participate. Title records are also confirmed by interface with one or more appropriate third party vendors. Once approved, the system notifies the property owner they are approved and automatically generates an agreement to be executed by all owners of the property. The home owner executes the agreement, preferably in front of a notary, and provides it to the system. In accordance with the various embodiments of the present invention, these steps can be performed entirely through automated electronic means, entirely manually or through a combination of automated electronic and manual means. The system then can notify the selected broker to facilitate entry of appropriate information into record keeping systems.

When the property owner decides to sell the property at a future date, the property owner notifies the organization. The organization can refer a broker to the property owner. The organization can also fulfill the role as a broker, or can sell the right to do so. In step 16, the organization refers a broker to the homeowner.

In step 18, a third party who is preferably a broker and who the organization has referred, acts as a broker to sell the property. The actual sale can be made at any time after the right to refer a broker has been obtained from the property owner, including many years afterwards.

The steps of FIG. 1 are performed by the organization on a plurality of properties.

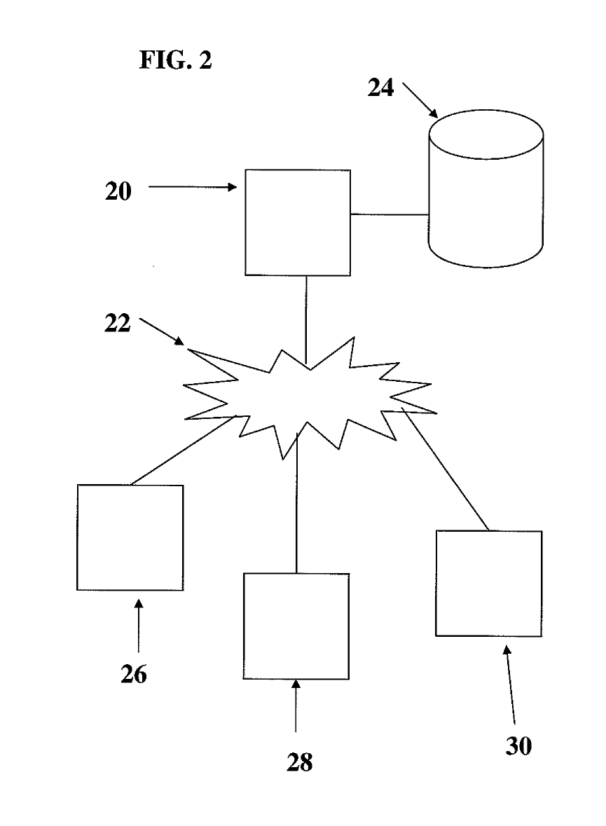

A personal computer or other stand-alone computer system can be used to implement the various aspects of the present invention. FIG. 2 illustrates another system that can be used to implement the various aspects of the present invention. A server 20 is connected to the internet 22. A database 24 is connected to the server 20. Client terminals 26, 28 and 30 are connected to the server 20 through the internet 22.

The client terminals 26, 28 and 30 are preferably, but not necessarily, located at local offices of the organization and the server 22 and database 24 are preferably, but not necessarily, located at the headquarters of the organization. Information concerning transactions consummated by the local offices is entered into the client terminals 26, 28 and 30, and uploaded to the server 20 for storage in the database 24. The server 20 then processes the stored data to determine the value of the transactions and the actual profit realized from the transactions.

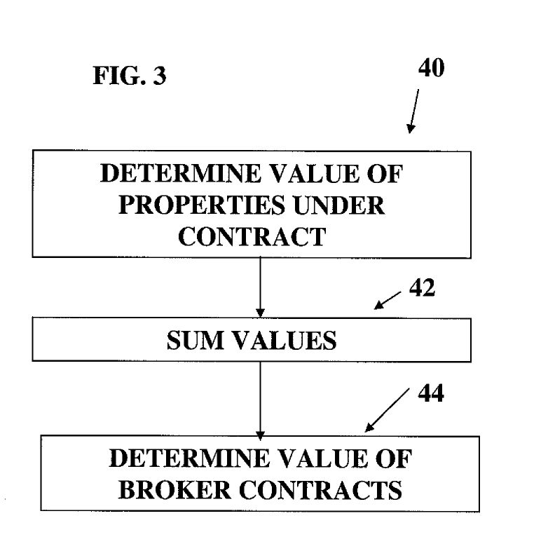

FIG. 3 illustrates a process in accordance with one aspect of the present invention. In step 40, the value or other parameters of the properties under the broker-related contract is determined. This determination is preferably determined at the local offices of the organization and entered through the client terminals 26, 28 and 30. The information concerning the property values is uploaded to the server 20 and stored in the database 24.

In step 42, the server 22 accesses all of the values or other parameters, and sums the values to determine a summed value.

The values of the properties under contract can be a present value of the properties. They can also be a projected value. Further, both a present value and a future value can be stored.

In step 44, the value of the broker contracts is determined. Alternatively, other parameters associated with the property can be summed. This value can be determined by taking a percentage of the summed value of the property values. Broker or agent services are normally performed for a percentage of the sales price of the property, and are normally collected at the closing on the sale of the property. The percentage used to determine the value of the broker contracts typically corresponds to the standard brokerage percentage.

Each of these steps can be performed by a stand-alone personal computer.

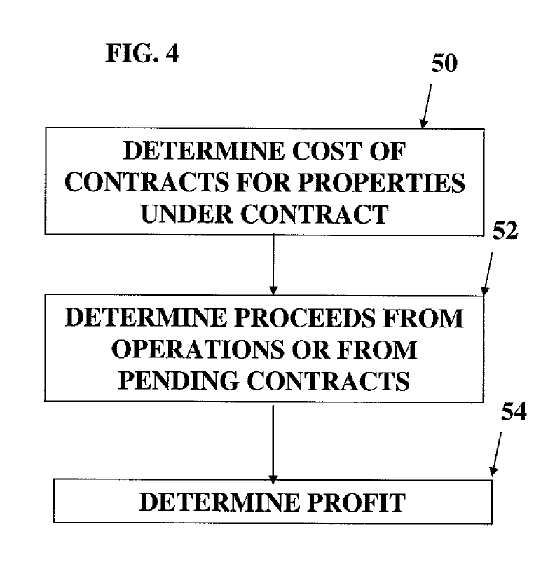

FIG. 4 illustrates another process performed in accordance with another aspect of the present invention. In step 50, the cost of broker contracts is determined for the properties under contract. These costs are typically entered at the client terminals 26, 28 and 30 at the local offices of the organization. These costs can either be stored in the database 24 connected to the server 20 or can be stored in local memory at the client terminals 26, 28 or 30.

In step 52, the proceeds from the broker contracts are determined. When the organization acts as the broker at the sale of a property, the proceeds are typically a percentage of the sales price of the property. Other costs associated with the sale of the property can also be entered.

When the organization sells the right to act as a broker, the proceeds are the amount a third party pays the organization.

In step 54, the profit is determined. These steps are performed for all properties where the organization owns broker rights.

The means for performing each of these steps includes the computers and software used to perform the described tasks.

In accordance with another aspect of the present invention, a system and method for tracking the interest expense tied to the financing of the consideration is provided. The system and method tracks the total interest payable to a third party in return for financing the consideration paid to the property owner. In accordance with one aspect of the present invention, the interest from financing is to be paid/repaid upon the closing of the property sale in the future

In accordance with a further aspect of the present invention, securitization of debt financing to be used for buying the consideration is provided. In accordance with this aspect, a derivative security is created based on the debt financing used.

Systems and method to use or process and track the activities of third parties—such as Dell, GM, etc.—to market the offer to refer a broker to broker the sale of property at a future date to their customers or prospective customers is provided. These activities will possibly provide increased sales to such third parties, or increased customer satisfaction due to the cash gain to the property owner customers due to the consideration provided by the organization.

Systems and methods to cross check new listings in the Multiple Listing System (MLS) against the records of the organization to prevent property owners who accepted the consideration for the future right to refer a broker to broker the sale of property from using a different broker/agent when they sell their property in the future. These systems and methods protect the rights to the fees associated with such sale.

In accordance with further aspects of the present invention, systems and methods to determine the value of the consideration to be available or offered to each individual property owner based upon the value of their specific property (either current value or future value) are provided. For example, owners of a property worth between $x and $y would be offered consideration equal to r, owners of a property worth between $y+$1 and $z would be offered consideration equal to s, owners of a property worth $z+$1 would be offered consideration equal to t.

Typically, a listing agreement provides the listing broker/agent with a fee based on a percentage of the property sale price, and that fee is usually split between the listing broker/agent, and the buyer's broker/agent.

Systems and methods to track agreements in place and send out periodic communications to remind the property owner of their obligation are provided. These communications can be in a form of annual greeting cards. Such communications are not necessarily legalese letters.

Systems and methods to track agreements in place and notify other brokers/agents of the agreements are also provided. Some states have laws/regulations that prohibit a real estate broker or agent from contacting another real estate broker or agent's clients, particularly those clients that have already entered into a listing agreement.

Systems and methods to process and track applications received either directly (in person, via the mail, via the Internet), or indirectly (through third parties making or delivering notice of the offer of consideration from the broker wanting the agreement for a future listing agreement) are provided.

In accordance with one aspect of the present invention a method is provided that stimulates homeowners to select a real estate broker today that they will use in the future when a homeowner chooses to sell his or her home.

To entice homeowners to select now a real estate broker they will use in the future when they choose to sell their home, in accordance with a further aspect of the present invention a consideration is offered to homeowners, and may include highly desirable items. As an illustrative example considerations may be in the form of major brand gift cards, each with a value of typically between $500 and $4,000. However other considerations may be provided. A consideration may have any value. However a value corresponding with a value lower than 1% of the value of the current home is preferred. In accordance with a further aspect of the present invention a transaction's consideration may be based upon approximate current home value. A party, by providing a homeowner with such consideration, may thus purchase the rights to a share of the Real Estate Broker commissions for future listing of a house of a qualifying homeowner.

Herein the term “party” will be used for an entity that may implement and perform the methods in accordance with one or more aspects of the present invention. Such an entity may be a person, a group of persons, a company, an institution, a group of entities or any other entity that can engage in legally binding agreements.

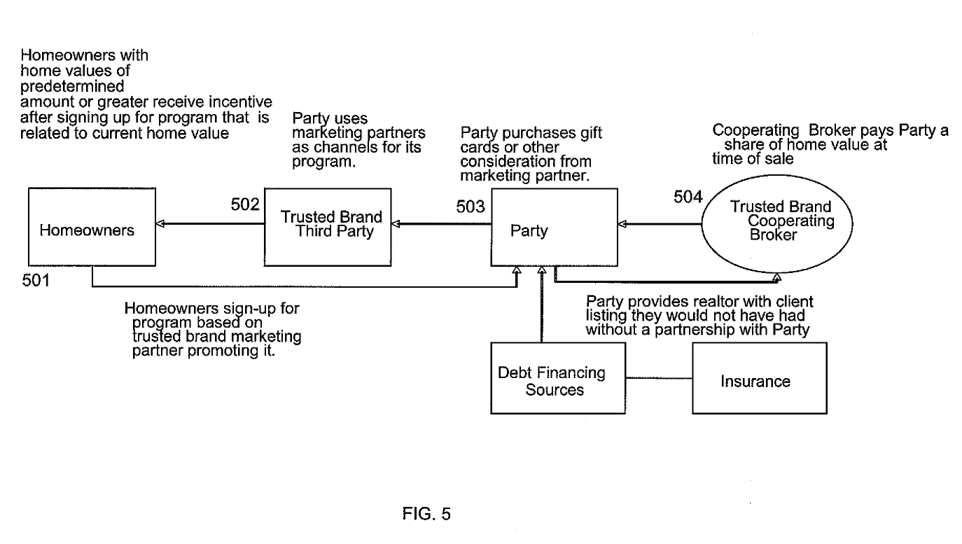

One embodiment of the process for a homeowner to commit to a real-estate agent or real-estate broker for a consideration is shown in diagram in FIG. 5. Herein a homeowner 501 signs up with a party 503 to commit to list the selling of a home to a broker 504 selected from a list of brokers provided by party 503. The party will provide a consideration to homeowner 501 for this right to provide a binding list of brokers. A consideration may be provided in the form of a product or service provided by a marketing partner 504. A party may provide a homeowner with a gift card of a certain value entitling the homeowner to select a product or service from the marketing partner up to the value of the gift card. Additional conditions may be included in the process of signing up a homeowner for the commitment to list. Steps and conditions of the methods which are also an aspect of the present invention will be described.

The party providing a consideration to a homeowner for listing rights is in effect selling pre-contracted for-sale listings and buyers to well known licensed real estate brokers. The party may negotiate with a real estate broker a compensation which may be a percentage of a sell-side commission generated in the future when a home captured by the party is sold through the real estate broker. A real estate broker is a licensed third party who is authorized to handle all activities for the home sales.

Real estate brokers and agents now in the industry have to compete to convince homeowners selling their homes in the immediate future to engage with them. In accordance with another aspect of the present invention a party is enabled to target all existing homeowners, regardless of when they plan to sell their homes. A party can thus address in an early stage a potential commission revenue pool of approximately one trillion dollars. A party can thus also generate net profits by stimulating homeowners to agree to use a real estate broker collaborating with the party for the future sale of their current home whenever in the future the homeowner decides to sell. In the U.S., according to the National Association of Realtors (NAR), that occurs on average every six years.

A party's primary cost per transaction will be the purchase of the consideration to be provided to the homeowner, primarily goods or services provided to each homeowner qualifying for such consideration. The party will incur related transactional costs per transaction, which may include credit checks, identity confirmation, confirmation of approximate home value, loan to value ratio, title holder validation, title check, data entry, and related expenses. Other costs to qualify a homeowner for a consideration may also be incurred.

In accordance with an aspect of the present invention the party will receive, in the future at the time a captured home is sold, a percentage of a sell-side commission earned by the homeowner selected sell-side licensed real estate broker with whom the party contracted to handle such sale, and to whom the party provided the listing. The party in accordance with a further aspect of the present invention may enter into agreements for additional transactions with a real estate broker with whom the party contracts to handle all real estate broker activities at the time a homeowner chooses to sell their home. Such transactions may include house preparation, entry into appropriate multiple listings service(s), placement of ads, signage on site, open house, showings, closings or any other common real estate broker or agent transaction.

According to the National Association of Realtors (NAR) 88% of U.S. home sellers in 2006 used a licensed real estate professional. So a party is asking targeted homeowners to accept consideration for doing something they are going to do anyway. According to the NAR, U.S. homes sold by licensed real estate professionals in 2005 sold for prices 16% higher than those that sold without the guidance of an experienced licensed Realtor. Accordingly a party is asking targeted homeowners to do something they already do, and something they should do, as doing so more than pays for itself.

The amount of annual commission flow in the U.S. continues to go up as home values continue to rise. More than 77% of home buyers are said to now seek out their new homes on the Internet prior to seeing them through a broker. As such, a variety of discount brokers have emerged over the last decade, some providing limited services, some providing full service. Discount brokerages have had a tough time entering the market experiencing limited growth and minimal success. A clear example of the failure of discount brokerages to succeed is the recent bankruptcy and termination of all activities by Foxtons. A variety of companies sell “leads” to real estate brokers and agents. Lead sources in most cases sell leads to multiple real estate brokers and agents per interested homeowner, some also collecting at the time of sale referral fees of as much as 0.9 to 1.35% of the home sale price upon sale. However, one must consider the time wasted by agents and brokers purchasing such leads, as when such leads are sold to 4 or 10 different brokers/agents; inherently the broker/agents buying such leads are wasting 75% to 90% of their time pursuing such leads because only 1 broker/agent in 4 or only 1 broker/agent in 10 may convert that single lead into a client. Accordingly generating “leads” are distinctly different from the methods provided herein as aspects of the current invention.

The real estate brokerage industry has existed and been growing for more than 100 years, with no fundamental changes. Recently, some entities are attempting to benefit from Internet technologies by saving homeowners a portion of the commissions paid by home sellers or home buyers, or providing home value information (www.Zillow.com would be one example).

Typically, when a home owner decides to sell his or her home, he/she enters into a Listing Agreement with a licensed real estate broker, usually dealing with a licensed agent affiliated with the licensed real estate broker. The prevailing commission rate is 6%, a portion of which, most often half, is shared with the real estate broker representing the Buyer. A real estate broker or agent most greatly impacts their income as a result of how many for sale listings they obtain in a given year and as a result of how many buyers they represent during the same year.

The Listing Broker enters the property information into a Multiple Listing Service (MLS), schedules and hosts an Open House for other local real estate brokers and agents (and sometimes possible buyers), shows the home as necessary to interested possible buyers and/or their real estate brokers and agents, handles price and terms negotiations, and facilitates the conclusion of the transaction. Commissions are paid upon the closing of the transaction.

It is known that several companies collect and sell leads to real estate brokers and/or agents, typically selling each lead to four to ten competing real esate brokers and/or agents. The future listings that are an aspect of the present invention have a much higher value than single leads sold to multiple agents/brokers. Real estate brokers who obtain future listings through early commitment do not waste 75% to 90% of their valuable time pursuing “listings” as they do when chasing a single lead sold to 4 to 10 agents/brokers by lead sources.

One of the many unique and innovative strengths of the methods provided herein in accordance with an aspect of the present invention is that rather than competing with other brokers and/or agents in the future when a home goes on the market and many brokers and agents in the U.S. are busy fighting over a reduced number of short-term home sellers, the party executing methods disclosed herein may capture a percentage of all targeted qualified homeowners now. This is far in advance of the typical point in time preceding a sale that a real estate broker or agent would even think about attempting to enter into a binding relationship with homeowners.

This capturing of a commitment of a homeowner by providing a consideration is an early investment that is not without risk. It is uncertain if a homeowner will sell his house within a reasonable time frame. To make capturing listing rights from homeowners an economically viable activity one should apply qualifying methods which are also aspects of the present invention.

One method of qualification may be to pre-set a lowest level of value of a house for which it is worth a consideration for a commitment to a future listing. One example of such a qualification is qualifying future listings with a median home value 50% higher than national median home values. Another qualification in accordance with an aspect of the present invention is to engage in future listings with well known licensed real estate brokers. By ensuring that reputable, licensed and successful real estate brokers will handle future listings a further enticement may be provided to a homeowner to sign up for a commitment to a future listing.

A further qualification in accordance with an aspect of the present invention is to engage with real estate brokers who commit in advance to a preset sharing of commission with the party who secured the commitment of the future listing by the homeowner. For instance such a qualification may be that the party will be paid a percentage of each sell-side commission ranging from 1.5%-1.8% of each home's value. Commitment to such a payment to the party is made by a real estate broker based on a sale in the future of a home referred to the real estate broker by the party.

Real estate brokers participating with a party are called Cooperating Brokers herein. Cooperating Brokers affiliated with the party will benefit from a meaningful volume of additional listing referrals that may reduce their marketing costs, and will allow them to maintain or increase their market share. Cooperating Brokers will most likely earn the same amount of money per transaction as they otherwise would per transaction. Cooperating Brokers' agents may make less per transaction. However, with the average licensed agent in the U.S. only handling 10 transaction sides per annum which shows an apparent average level of inefficiency, it is certainly possible that Cooperating Broker agents that receive Party listings may easily earn more per annum and spend less time marketing themselves by using the listing commitments obtained by the party and benefiting from qualifications performed as part of obtaining those commitments.

In accordance with a further aspect of the present invention a homeowner enrollment agreement is provided. Such an agreement is a document that describes the legal agreement between the party and the Consumer who agrees to receive consideration now in exchange for committing to use a Broker cooperating with the party when they sell their home at some point in the future. In accordance with a further aspect of the present invention a homeowner is allowed to modify the initial selection of a Broker one or more times prior to entering into a listing agreement in the future when he or she sells the home that is the object of the agreement.

In accordance with another aspect of the present invention a Cooperating Broker Referral Agreement (CBRA) is provided. Such an agreement is a document that provides the terms and conditions of the legal agreement between the party and its Cooperating Brokers. As a Cooperating Broker, the Broker is eligible to receive listing referrals from the party, and in return compensates the party by paying the party a share of the sale price of each referred home. Such a share may be 1% of the sale price, it may also be 2% of the sale price. Or it may be any share or equivalent to any share of the sale price of a home that has been agreed upon. The party may be paid through escrow at closing.

Elements which the CBRA may contain are:
The referral fee structure of the gross commission. This may contain a minimum fee, which may be a pre-determined percentage of the sale price of the home. It may also contain a maximum fee, which may also be expressed as a percentage of the sale price of the home;
The term of the Agreement. Terms and conditions for automatic annual renewals thereafter may also be included;
The details outlining how the party is paid at closing through the escrow agent or trustee disbursing funds at closing;
Responsibilities of the Cooperating Broker to update the party for instance via a Cooperating Broker web interface at specific points during the listing engagement and home sale process. Elements that may be included in an update are: execution of listing agreement and price at which home is listed, entry of home into the local MLS and the unique MLS number, acceptance of a bona fide offer and the offer price, scheduled closing dates or any modifications thereto, and a final confirmation of the closing having occurred. Other elements may also be included; and
Language prohibiting the Cooperating Broker from entering into agreements with any other party that could interfere with the Cooperating Broker fulfilling its obligations to the party.

Other terms and conditions may also be part of an agreement.

In accordance with another aspect of the present invention the party has a real estate broker license in the location where the party will be active in obtaining a listing referral commitment from a home owner.

As a further aspect of the present invention the party may select a Brand Marketing Partner from whom the consideration for homeowners will be acquired. A Brand Marketing Partner is preferably a Fortune 200 consumer brand company. However a brand marketing partner may be any company that provides products and/or services for customers. Considerations offered to homeowners should be viewed as desirable and of value. Accordingly the party as an aspect of the present invention may gather data and analyze regularly what forms of homeowner Consideration, and which of the Brand Marketing Partners and which of their methods, products or services, are attracting the most homeowners to respond to and accept an offer to commit to a future referral for a listing.

Referring to FIG. 5, the insurance operation insures the enforceability of the contract with a homeowner. It can also insure the enforceability of the Cooperating Broker agreement with the party.

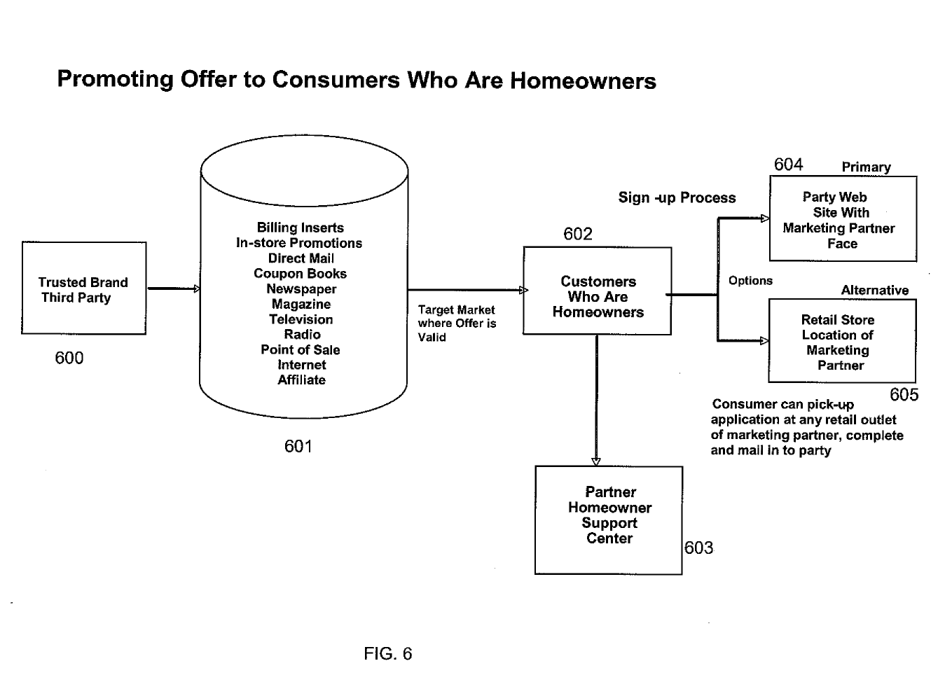

In accordance with another aspect of the present invention the party may require a third party to promote the offer from the party and cover promotion and advertising expenses. A diagram describing one embodiment of such promotion is provided in FIG. 6. Herein 600 is a Marketing Partner possibly with retail store outlets. A Marketing Partner can be any entity with a retail outlet, an Internet store or a service provider. In a step 601, the partner disseminates information about the program. This may be through billing inserts, advertising, direct mail or any other way that will bring the program to the attention of a homeowner 602 who is also a customer of the partner. The marketing partner may assist in providing a means for application to the homeowner. Support for filling out and submitting an application is available from a support center 603, which may be operated by the partner. Application by a homeowner 602 who is a customer of the partner 600 for the consideration may take place through a webpage 604, which has an image related to the partner. Application may also take place in retail stores 605 operated or owned by marketing partner 601. Application may also take place through a website from a partner, which may be part of a website which sells products or services by or from the marketing partner.

In accordance with a further aspect of the present invention category exclusivity to a major brand marketing partner may be granted and, if desired, only one Marketing Partner is engaged in a category segment. If desired, however, more can be engaged. In accordance with an aspect of the present invention a trusted brand marketing partner has to qualify based on one or more of the following requirements:
Major Brand: A potential partner should be a financially stable trusted Consumer Brand, well known within its vertical segment and well respected by its customer base. Partner Brand awareness and vertical leadership increase the perceived credibility of the party's offer.
Consumer Desire for Incentive: Product or services available through the use of a gift card provided by Trusted Brand Marketing Partners must be of meaningful value and highly desirable to stimulate homeowners to take advantage of the party's offer.
Promotion/Advertising Investment: A Trusted Brand Marketing Partner must commit to a major national promotion of the offer to ensure success of the program. Brand Partner may use integrated marketing channels such as direct mail, billing inserts, in-store promotions, print and TV advertising, Internet, etc.
Potential Size of Targeted Customer Base: A Marketing Partner's existing customer base or access to consumers must be substantial and measured in tens of millions.

In accordance with another aspect of the present invention the value of the consideration for future listing of a home such as the retail value of a gift card will be tied to the current home value of a participating homeowner. The value of a home and of the size of the consideration may be determined according to for instance value categories. A category may include a value range. For instance a first category may be a value less than $120,000; a second category may be equal to or greater than $120,000; etc. Other forms of value categories may also be used.

In accordance with an aspect of the present invention a homeowner may have to meet one or more of the following requirements before a consideration is actually provided to a homeowner:
A homeowner has entered into the Homeowner Enrollment Agreement;
A homeowner has been approved by party based on qualifications which may include an acceptable credit score which may be a FICO credit score, current Loan-to-Value (LTV) ratio of the home, approximate home value, identity confirmation and confirmation of home ownership;
A homeowner has provided a personal guarantee on the obligations of the agreement, including the homeowner's obligation to use a Cooperating Broker.

The methods which are provided herein as an aspect of the present invention provide the party with information which may be used by the party to generate additional revenues. For instance, according to the NAR, 50% of sellers in 2006 used the same broker for their new home purchase as they used for their then current sale. In accordance with another aspect of the present invention, the written agreement with Cooperating Brokers may include entitlement to a second referral fee from the Cooperating Broker to whom the party provided the homeowner for a listing if the referred property seller uses a Cooperating Broker for the concurrent purchase of a new home.

In addition, as the party will likely be the first in the country (other than the homeowners) to know when the homeowners are about to sell, the party will have many opportunities to reap additional rewards through repeat business and additional referral fees from various vendors for services such as: movers, title insurance, homeowners insurance, lawn care, telecommunications services, refuse removal, storage space, home repair, energy and more. In accordance with a further aspect of the present invention additional referral fees may be obtained from product and service providers who are potentially interested in customers who will move out of a house or move into a house.

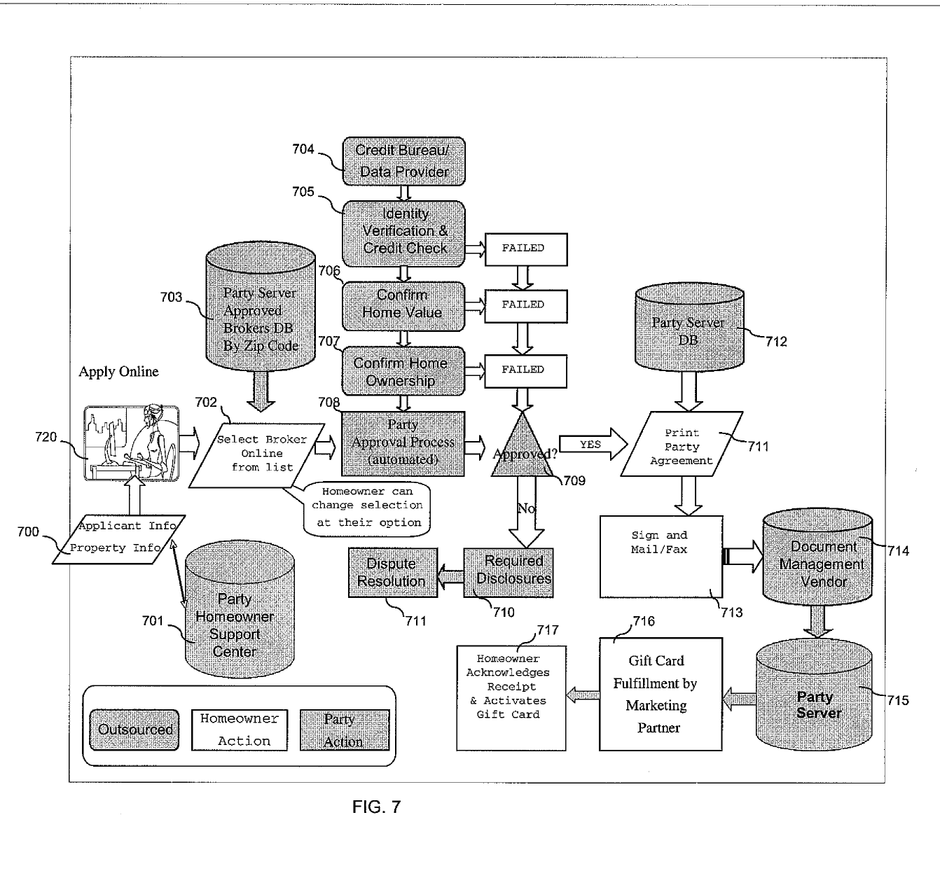

Flow charts are provided in FIGS. 7-9 that describe a sign-up process for the Homeowner. FIG. 7 describes an illustrative embodiment of an on-line sign-up process with a signed hard copy agreement. A homeowner or applicant in step 720 is connected through a network, which preferably is the Internet, to a server which is managed or under control by the party. The server provides several functions of which several will be individually identified. Other functions as known to persons of ordinary skills in creating websites, such as for instance providing the correct screens and security management are assumed but not shown. The homeowner or applicant in step 700 enters relevant homeowner information and information related to a property. A Party Homeowner Support Center which may provide support for instance on-line, through e-mail, instant messaging or phone or in any other way that may assist the applicant with filling out the application is shown in a step 701. An applicant selects online a broker from an approved list in a step 702. Such an approved list is provided on-line by a Party Server in step 703. The server in step 703 may provide a list of approved brokers based on a zip code. The Homeowner can change the selected broker later. The process goes through a series of steps to verify the provided information and to qualify an applicant or homeowner for a consideration. This merely describes one embodiment of the present invention. Other embodiments can also be used.

In one embodiment the application data is provided to an outside party such as a credit bureau or data provider in a step 704. An identity verification and credit check is performed in step 705 in which an applicant can pass or fail. In step 706 the value of a home is checked, in which an applicant can pass or fail. In step 707, ownership of a home is checked. The results of all checks are provided in a step 708, which may be performed by a computer program or by a person or by a combination thereof. The checking process may contain further steps or fewer steps than shown here. In step 709, it is checked if the application is approved or rejected. If rejected in step 710 an applicant will be informed that he or she doesn't meet the criteria and will be provided the proper disclosures required by law under the FCRA (Fair Credit Reporting Act). If an applicant does not agree with a rejection a dispute resolution step 711 may be applied.

If approved, an agreement may be printed in step 711 and provided to an applicant. Information related to an agreement may be available from a Party Server in step 712. In step 713 an applicant or homeowner signs the agreement and returns the signed agreement by mail, fax or by other means. In this step or in a separate step the homeowner may also indicate the preferred form of consideration. The signed agreement may be processed in step 714 by an outside document management vendor. In a further embodiment it may also be processed by the party. In step 715 the data and information related to an agreement may be entered into a party server. In step 716 a Marketing Partner is informed of the homeowner's entitlement to a consideration and for instance a gift card to the homeowner is authorized. In step 717 the homeowner is provided with the gift card. A confirmation of receipt and activation of the gift card may be included in step 717.

Processing of the steps when required may be performed by the party. Processing of the steps may also be performed by outside parties, which may be partners or contractors.

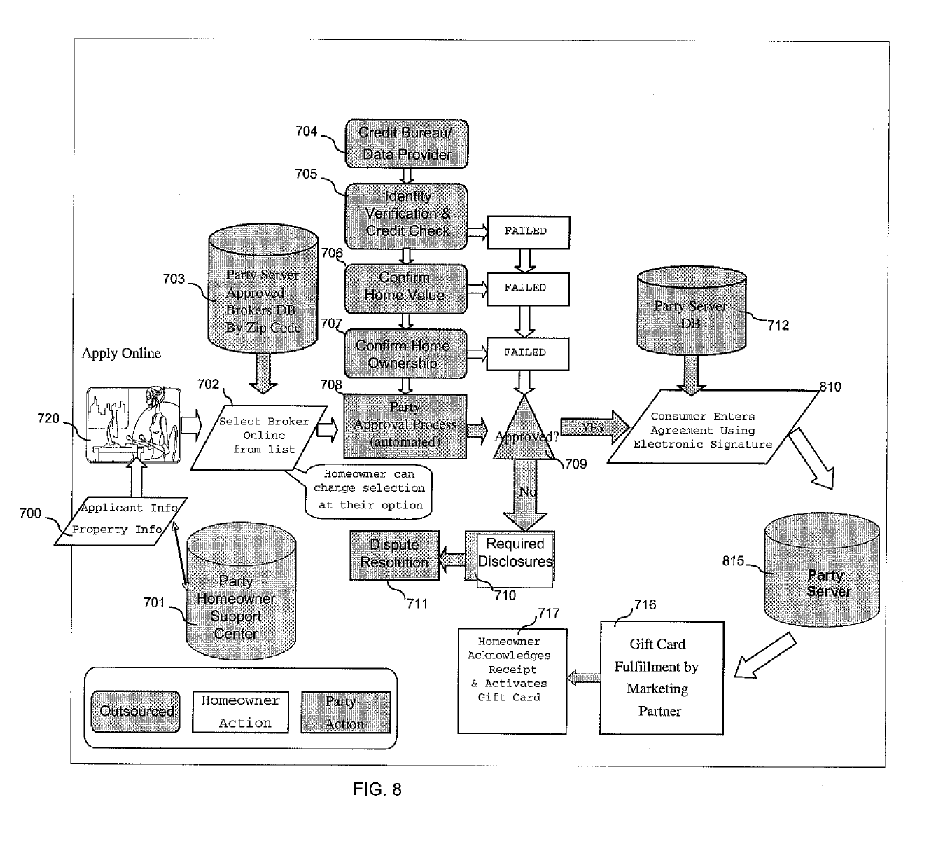

In a further embodiment a homeowner after approval provides an electronic signature to sign an agreement. This embodiment circumvents steps of generating paperwork after the homeowner was approved. An illustrative flow diagram showing steps of an embodiment using an electronic signature is shown in FIG. 8. The diagram of FIG. 8 may have considerable similarities with FIG. 7. However steps 711, 713, 714 and 715 are replaced by a step 810 wherein the homeowner enters into an agreement with an electronic signature. The electronic signature is provided in step 815 to a party server which may generate an electronic document to the consumer to confirm the agreement. It is still possible in a further embodiment to generate a printed copy and send it to the homeowner. In step 815 a message is generated to a Marketing Partner related to the consideration for the homeowner. This is preferably an electronic message. The consecutive steps may be identical to the steps in FIG. 7.

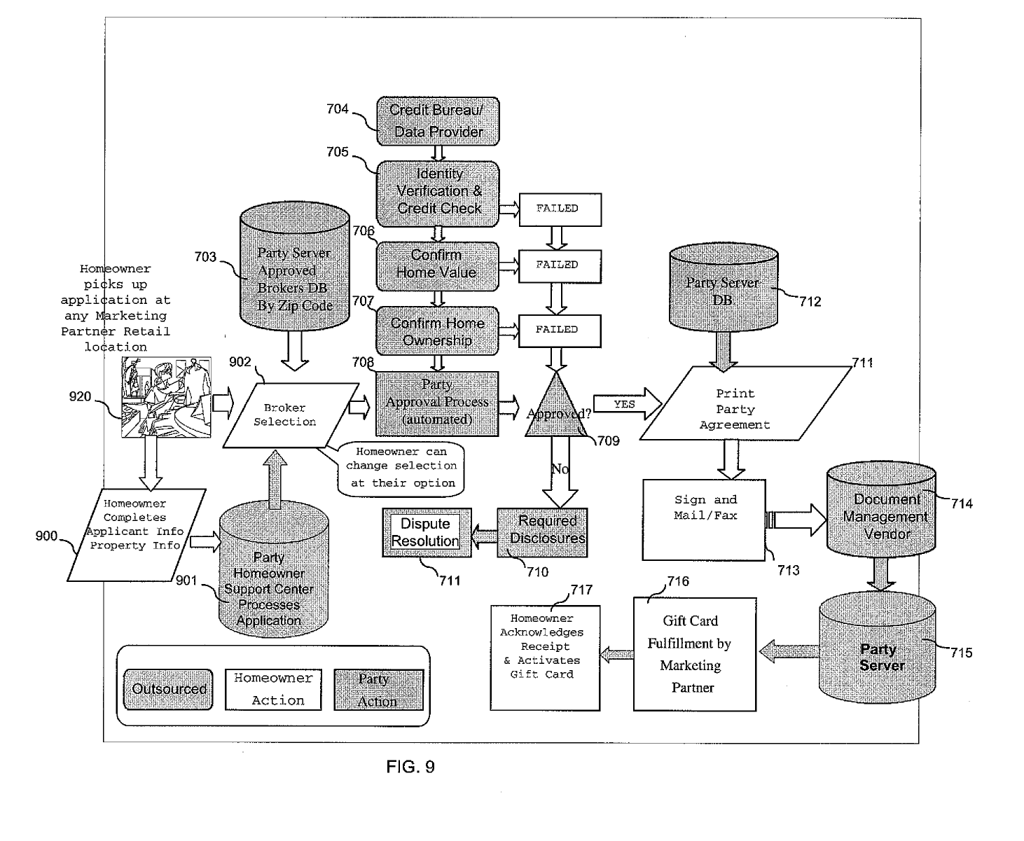

In yet a further embodiment the application by the applicant or homeowner is done on paper and not on-line. For instance an applicant may become aware of the consideration program at for instance a Marketing Partner Retail location. Possible steps in accordance with such an embodiment are shown in diagram in FIG. 9. In step 920 a homeowner picks up an application in a Marketing Partner Retail location. In step 900 an application form is completed and in step 901 submitted to a support center which may transform the application into electronic form. This allows the application to be processed as in FIG. 7. The homeowner in step 902 selects a broker. This may be first done during application. A broker may also be selected or a selection of a broker may be changed in a later stage. The further steps of FIG. 9 may then be identical to the steps as shown in FIG. 7.

In accordance with a further aspect of the present invention as part of the sign-up process, homeowners may establish an online log-in with password which will enable them to change their Cooperating Broker selection at any time or submit questions they might have for the party. In addition, as part of the sign-up process, consumers may have the option of providing their contact information to the Cooperating Broker they selected at that time or they may choose to wait until they are ready to list their home for sale.

A Homeowner desiring to talk directly with the Cooperating Broker they have selected may have the option of having the Cooperating Broker contact them or they may contact the Cooperating Broker directly. When the homeowner is ready to list their home for sale they must inform the party as part of their Homeowner Enrollment Agreement which may also be called HEA.

In accordance with a further aspect of the present invention homeowners who previously entered into a Homeowner Enrollment Agreement may receive an annual (or more frequent) communication from the party reminding them of their obligation to the party program and their selected Cooperating Broker. They may receive both email notifications which may be sent at least quarterly and a letter in the mail which may be sent at least once a year. These communications may be automated. To increase the value of these communications, the party may include communications that include some timely information and content in areas such as real estate trends, moving tips, special offers from third parties, such as a Trusted Brand Marketing Partners, etc.

In accordance with another aspect of the present invention the party may monitor all program participants closely to ensure that they comply fully with the terms they agreed to in the HEA to ensure that the party receives the agreed upon commission split from the Cooperating Broker at closing. Three distinct scenarios as illustrated below can potentially occur.

Scenario 1 illustrates how the process should occur if all parties adhere to the agreement. Scenarios 2 and 3 illustrate what could potentially happen if either party does not comply with the terms of their agreement.

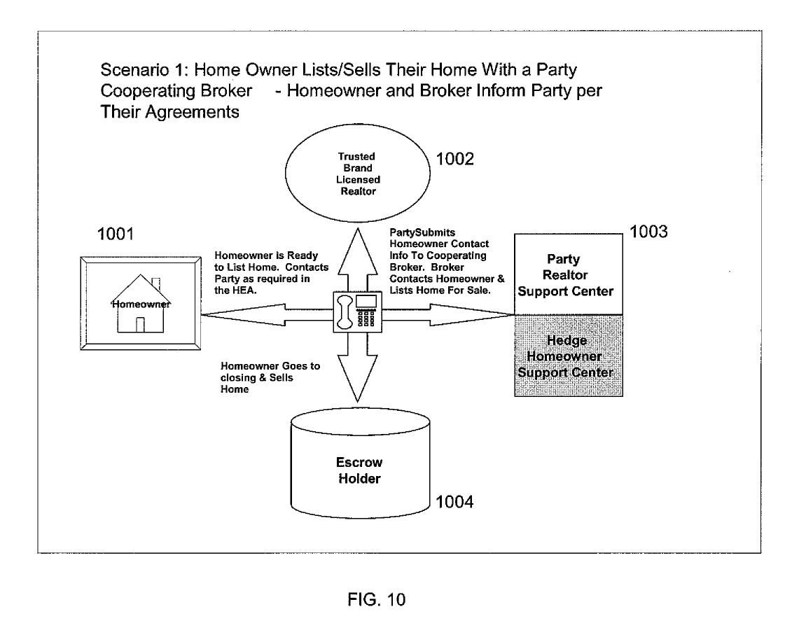

FIG. 10 illustrates an embodiment of the process in accordance with scenario 1. A homeowner 1001 is ready to list his home with a broker. He contacts the party or a party representative 1003 as required in the HEA. The party or representative 1003 submits homeowner contact information to a Cooperating Broker 1002. The broker 1002 contacts the homeowner 1001 and lists the home for sale. The home sells and goes into escrow 1004.

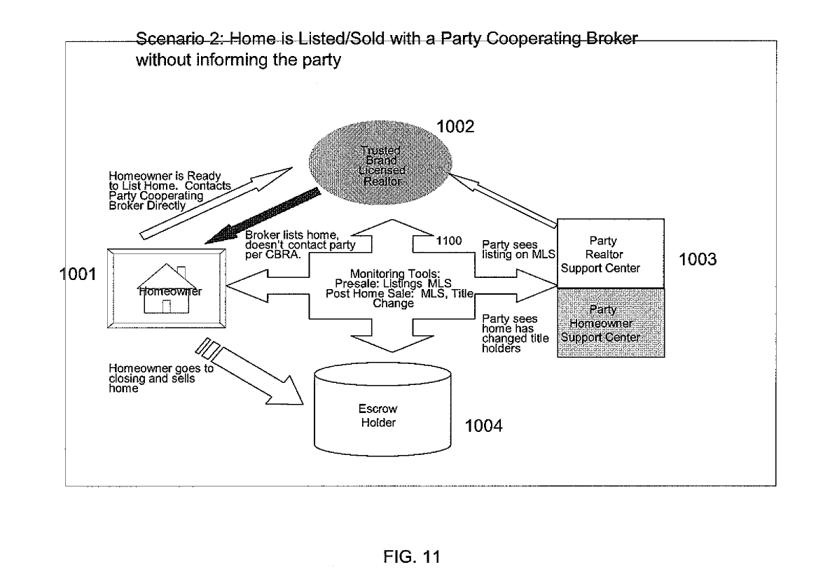

FIG. 11 illustrates scenario 2, wherein the home is listed/sold with a Cooperating Broker without informing the party. In accordance with a further aspect of the present invention monitoring tools 1100 may be used to detect non-compliance with the agreement. When non-compliance is detected, the party may contact participating homeowner 1001 to remind him of his obligation per the HEA. For instance a Multiple Listing Service (MLS) listing of a home that is in a signed agreement with the party may be detected and is found to be listed without officially informing the party. The party or its representative 1003 may inform the listing broker 1002 and the homeowner 1001 of their obligations. Failure to cooperate will generate the filing of Lis Pendens prior to sale. Party may also detect a change of ownership of the house. In the event closing has occurred the party will require payment in full.

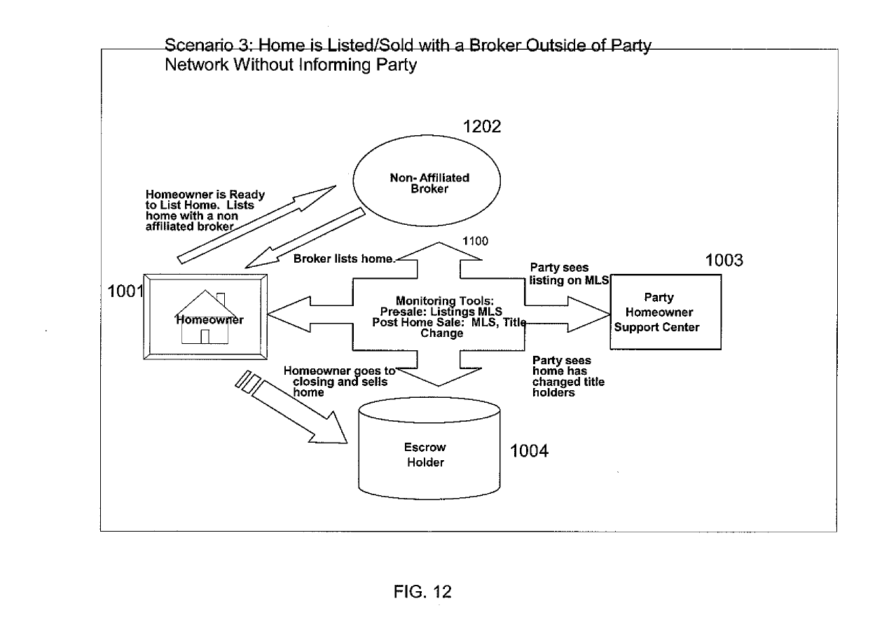

FIG. 12 illustrates scenario 3, wherein the home is listed/sold with a broker 1202 who is not a Cooperating Broker, without the homeowner 1001 informing the party. In accordance with a further aspect of the present invention monitoring tools 1100 may be used to detect non-compliance with the agreement. When non-compliance is detected, the party may contact the participating homeowner to remind him of his obligation per the HEA. For instance a Multiple Listing Service (MLS) listing of a home that is in a signed agreement with the party may be detected and is found to be listed without officially informing the party. The party or its representative 1003 may inform the homeowner 1001 of his obligations. Failure to cooperate may generate the filing of Lis Pendens prior to sale. The party may also detect a change of ownership of the house. In the event closing has occurred the party will require payment in full.

In accordance with an aspect of the present invention the party may monitor Homeowners participating in the program and the Cooperating Brokers through continuous monitoring of listings and sales. An automated process to identify a listing before it goes to closing utilizing various resources may also be applied.

Pre-Close Monitoring: The party may establish membership & subscriptions with MLS providers and other data sources such as Realtor.com, Zillow.com, Trulia.com, ForSaleByOwner.com to flag any participating Homeowner who lists their home without notifying party per their HEA. As described in Scenario 2 above, the Cooperating Broker may be contacted by the party to remind them of their contractual obligations.

Post-Sales Monitoring: Party may reconcile any change of title for a property linked to participating homeowner through an automated process on a continuous basis. This post sales audit procedure may be done on a regular basis pinging contracted title vendor's data base and/or credit report vendor's database. Based on title change reporting in over 3000 counties in the U.S., the time lag between when a property is sold and the title is updated ranges from approximately 4 days to 3 weeks. Most large U.S. metropolitan areas, which may comprise a majority of homes targeted by party, are computerized and typically affect title changes within a few days.

In order to manage Cooperating Broker network in accordance with a further aspect of the present invention a web portal is created that serves as a database management tool with reporting and mapping functionality. To illustrate, a few examples of the functionality of this tool are provided.

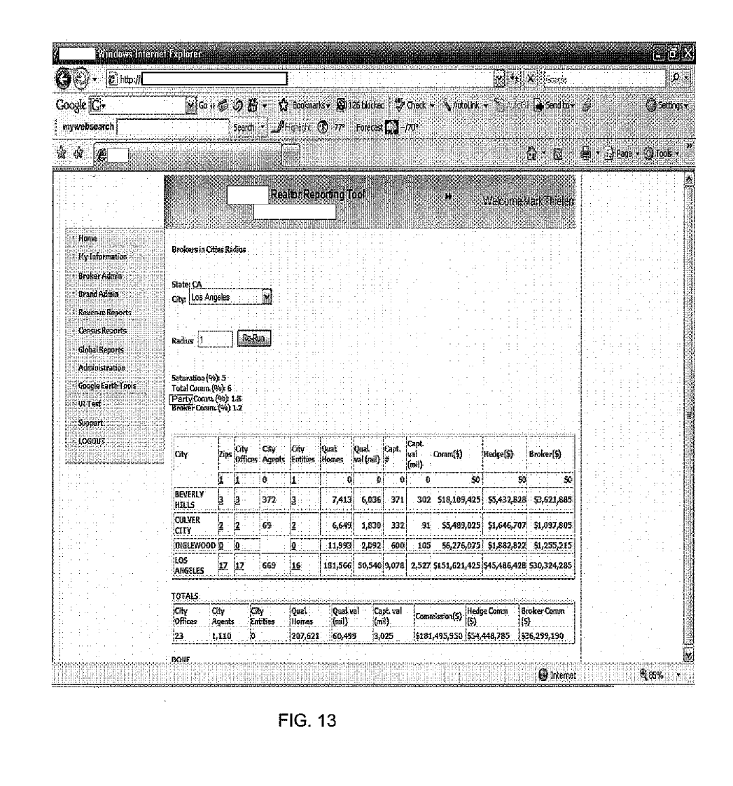

FIG. 13 shows links to all party's Cooperating Brokers in Los Angeles along with how many qualified homes are located within Los Angeles and how many homes are captured at a 5% capture rate and the resulting commission flow to party.

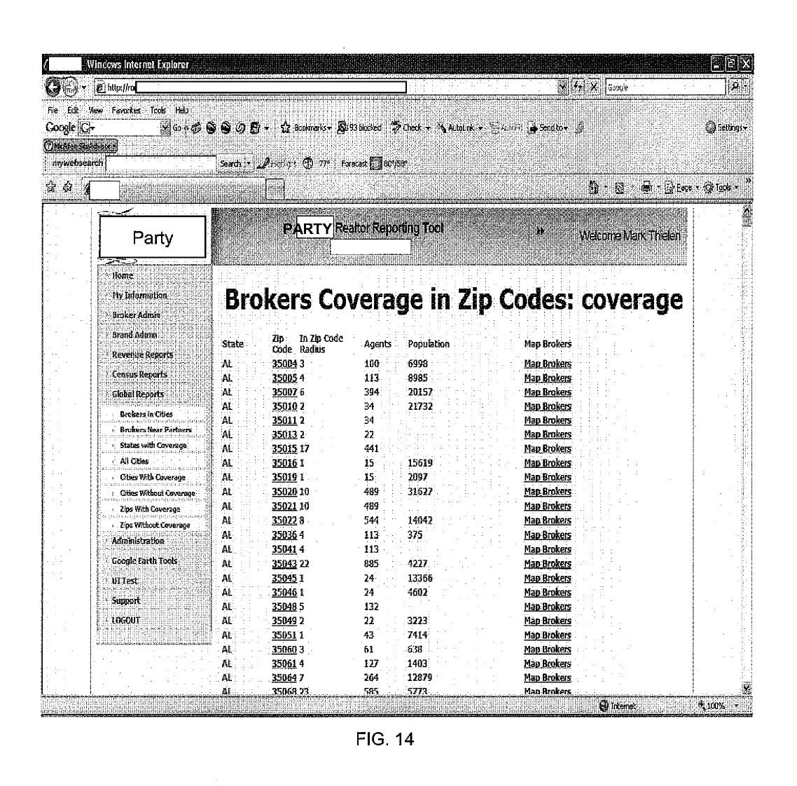

FIG. 14 shows by zip code how many brokers and agents are in party's network with a link to those brokers and their branch offices along with a link to a Google map that displays the offices within that zip code.

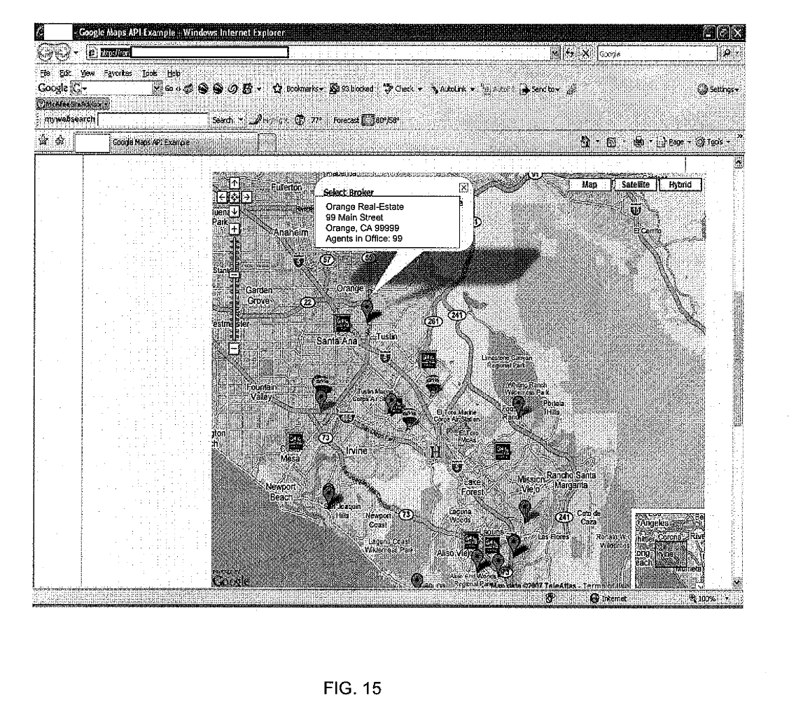

FIG. 15 is a Google map that displays all offices within 10 miles of the party symbol on the map with a tag link that displays office information.

In accordance with another aspect of the present invention a computer system is provided that implements one or more of the methods provided herein as aspects of the present invention. Such a computer system may have one or more processors, one or more databases, and one or more storage and memory means. The computer system may be a centralized computer system. It may also be a distributed computer system. The computer system has means for storage and retrieval of data. Such means may be storage disks, such as magnetic disks or optical disks, tapes, memory elements or any other means or medium that allows storage and retrieval of data by a processor. The data storage means in accordance with an aspect of the present invention may store records related to applications for a consideration by a homeowner; it may also store and make available lists of qualified real-estate brokers, it may store records related to qualification of applying homeowners; it may also store agreements between party and a homeowner. Furthermore the storage means may also store any record between a party and a marketing partner. Furthermore the storage means may store any record, including but not limited to any electronic document and electronic message related to the party, a homeowner, a marketing partner and a broker. Furthermore the computer system may be connected to a network, preferably the Internet. Data may be entered into the system or retrieved from the system via the network. Partners may be connected to the computer system via a network and enabled to exchange information with the computer system. Applicants and homeowners may also exchange information with the computer system via a network.

Herein the terms “consideration” and “gift card” are used. A gift card, which may be valid at a marketing partner, is one form of a consideration. A consideration may be any product or service that is of value to a homeowner. It may be a real product. It may be a service such as a travel service, which may be for instance an airline ticket. It may also be a value of a product or a service that may be obtained or used at a time in the future. Such a value may be expressed as a gift card. A gift card may thus be a real card. It may also be a value of a product or a service which may be provided for instance by a marketing partner to the homeowner by identifying himself to the marketing partner preferably in a secure way. A consideration may also be cash or a financial product representing a cash value.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

I claim:

1. A method for an owner of a property to sell the property, comprising:
the owner applying to a party for a consideration for committing to sell the property with a real estate broker associated with the party; and
the party qualifying the owner before providing the consideration to the owner.

2. The method as claimed in claim 1, further comprising selling the property through the real-estate-broker.

3. The method as claimed in claim 1, further comprising the party providing the consideration to the owner after qualifying the owner.

4. The method as claimed in claim 1, wherein the real estate broker is selected from a plurality of real estate brokers provided by the party.

5. The method as claimed in claim 1, further comprising providing the party with a compensation based on a value of the property.

6. The method as claimed in claim 3, wherein the consideration is a gift card for a product or a service from a third party.

7. The method as claimed in claim 1, wherein the owner applies through a computer connected to an Internet.

8. The method as claimed in claim 6, wherein the third party is a retail outlet and the owner applies for the consideration through the retail outlet.

9. The method as claimed in claim 8, wherein the retail outlet is a website.

10. The method as claimed in claim 1, wherein the qualifying of the owner includes a credit check.

11. The method as claimed in claim 1, wherein the qualifying of the owner includes determining a value of the property.

12. The method as claimed in claim 1, wherein the qualifying of the owner includes:
determining a loan to value associated with the property;
verifying the identity of the owner; and
a title check to verify the owner has proper title.

13. A system for obtaining a commitment by an owner to list a property for sale with a real estate broker provided by a party, comprising:
a processor;
a data storage means;
software operable on the processor to:
receive an application by the owner for a consideration for committing to list the property with the real estate broker provided by the party;
qualifying the owner to receive the consideration; and
storing data related to a commitment by the owner to sell the property with the real-estate broker provided by the party.

14. The system as claimed in claim 13, wherein the software generates an agreement between the owner and the party.

15. The system as claimed in claim 13, wherein the software generates an electronic message informing a third party to provide the consideration to the owner.

16. The system as claimed in claim 13, wherein the owner applies for the consideration by using a computer device connected to the system.

17. The system as claimed in claim 13, wherein the qualifying of the owner includes a credit check.

18. The system as claimed in claim 13, wherein the qualifying of the owner includes determining a value of the house.

19. The system as claimed in claim 13, wherein the qualifying of the owner includes:
determining a loan to value associated with the property;
verifying the identity of the owner; and
a title check to verify the owner has proper title.

20. The system as claimed in claim 13, further comprising:
storing a record related to the owner deciding to sell the property;
storing a record related to informing the real-estate broker of the decision of the owner; and
storing a record related to a sale of the property.
